(19) United States
(12) Patent Application Publication
(10) Pub. No.: US 2009/0015809 A1
(43) Pub. Date: Jan. 15, 2009

(54) Image Recording Method and Device

(75) Inventors: Issei Suzuki, Kanagawa-ken (JP); Katsuto Sumi, Kanagawa-ken (JP); Kazuteru Kowada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/887,386

(22) PCT Filed: Mar. 28, 2006
(86) PCT No.: PCT/JP2006/306361

§ 371 Date: Jan. 10, 2008

(30) Foreign Application Priority Data
Mar. 28, 2005 (JP) 2005-091682
May 31, 2005 (JP) 2005-159750

(51) Int. Cl. G03B 27/42; G06F 17/50

(52) U.S. Cl. 355/53; 716/21

(57) ABSTRACT

A test pattern is formed on a substrate based on test data supplied from a test data memory and a line width of a test pattern is measured. Mask data is set to have a specified micromirror of a DMD, which constitutes exposure heads in an off state fixedly at a mask data setting section, so that a light quantity is corrected by a line width changing quality.

### TECHNICAL FIELD

The present invention relates to an image recording method and an image recording apparatus (device) for controlling a number of recording components arrayed along an image recording medium depending on image data to record an image on the image recording medium.

### BACKGROUND ART

FIG. 24 is a view illustrative of a process of manufacturing a printed wiring board. A substrate 2 with a copper foil 1 deposited thereon by evaporation or the like is prepared. A photoresist 3 made of a photosensitive material is pressed with heat against (laminated on) the copper foil 1. After the photoresist 3 is exposed to light according to a wiring pattern by an exposure apparatus, the photoresist 3 is developed by a developing solution. Then, the portion of the photoresist 3 which has not been exposed is removed. The copper foil 1 that is exposed by the removal of the photoresist 3 is etched away by an etching solution. Thereafter, the remaining photoresist 3 is peeled off by a peeling solution. As a result, a printed wiring board having the copper foil 1 left in the desired wiring pattern on the substrate 2 is manufactured.

There has been developed a spatial light modulator such as a digital micromirror device (DMD) or the like, for example, as the exposure apparatus for recording the wiring pattern on the photoresist 3 (see U.S. Pat. No. 5,132,723). The DMD comprises a number of micromirrors tiltably disposed in a grid-like array on SRAMs (memory cells). The micromirrors have respective surfaces with a highly reflective material such as aluminum or the like being evaporated thereon. When a digital signal representative of image data is written into SRAM cells, the corresponding micromirrors are tilted in a given direction depending on the digital signal, selectively turning on and off light beams and directing the turned-on light beams to the photoresist 3 to record a wiring pattern by exposure.

The light beams reflected by the respective micromirrors and led to the photoresist 3 may have different intensities, beam diameters, beam shapes, etc., depending on the location. On the substrate 2 where the wiring pattern is to be formed, the laminated state of the photoresist 3 may differ depending on the location due to irregularities of heating temperature and pressure, and chemical reaction rates may become irregular in chemical processes such as the developing process and the etching process. For these reasons, it may not be possible to form wiring patterns of desired line widths on the substrate 2.

### DISCLOSURE OF THE INVENTION

It is a general object of the present invention to provide an image recording method and an image recording device which are capable of recording a desired image highly accurately on an image recording medium.

A major object of the present invention is to provide an image recording method and an image recording device which are capable of making adjustments in view of the state of recording components or an image recording medium.

### BRIEF DESCRIPTION OF THE DRAWINGS

FIG. 1 is an external perspective view of an exposure apparatus according to an embodiment of the present invention;

FIG. 2 is a schematic view of an exposure head of the exposure apparatus according to the embodiment;

FIG. 3 is an enlarged fragmentary view showing a DMD employed in the exposure head shown in FIG. 2;

FIG. 4 is a view illustrative of an exposure recording process performed by the exposure head shown in FIG. 2;

FIG. 5 is a diagram showing the DMD of the exposure head shown in FIG. 2 and mask data set in the DMD;

FIG. 6 is a diagram showing the relationship between a recording position and an amount-of-light locality in the exposure apparatus according to the embodiment;

FIG. 7 is a diagram showing a line width recorded when the amount-of-light locality shown in FIG. 6 is not corrected;

FIG. 8 is a diagram showing a line width recorded when the amount-of-light locality shown in FIG. 6 is corrected;

FIG. 9 is a block diagram of a control circuit of the exposure apparatus according to the embodiment;

FIG. 10 is a flowchart of a process of setting mask data which is performed by the exposure apparatus according to the embodiment;

FIG. 11 is a diagram showing a test pattern recorded on a substrate by the exposure apparatus according to the embodiment;

FIG. 12 is a diagram showing the relationship between the positions of the test pattern shown in FIG. 11 and measured line widths;

FIG. 13 is a diagram showing the relationship between changes in the amount of light of a laser beam applied to the substrate and corresponding line width changes;

FIG. 14 is a diagram showing the relationship between the position of the substrate and the amount-of-light correction variables;

FIG. 15 is a diagram illustrative of a halftone dot pattern recorded on a substrate by the exposure apparatus according to the embodiment;

FIG. 16 is a diagram illustrative of grayscale data as test data;

FIG. 17 is a diagram illustrative of a copper foil pattern formed on a substrate using the grayscale data shown in FIG. 16;

FIG. 18 is a diagram showing another test pattern recorded on a substrate by the exposure apparatus according to the embodiment;

FIG. 19 is a view showing an edge area formed along a direction in which a substrate is scanned;

FIG. 20 is a view showing an edge area formed along a direction perpendicular to a direction in which a substrate is scanned;

FIG. 21 is a diagram showing the relationship between amounts of change in the amount of light and in line width on photosensitive materials of different types;

FIG. 22 is a diagram showing the relationship between the position of the substrate and the line width on photosensitive materials of different types;

FIG. 23 is a diagram showing the relationship between the position of the substrate and the amount-of-light correction variables on photosensitive materials of different types; and

FIG. 24 is a view illustrative of a process of manufacturing a printed wiring board.

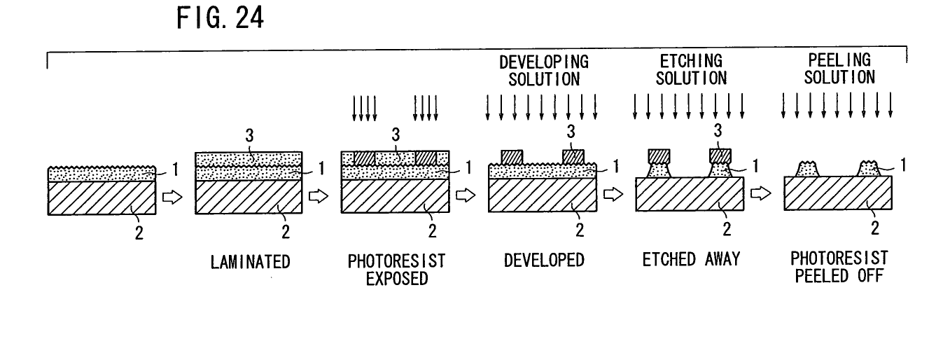

### BEST MODE FOR CARRYING OUT THE INVENTION

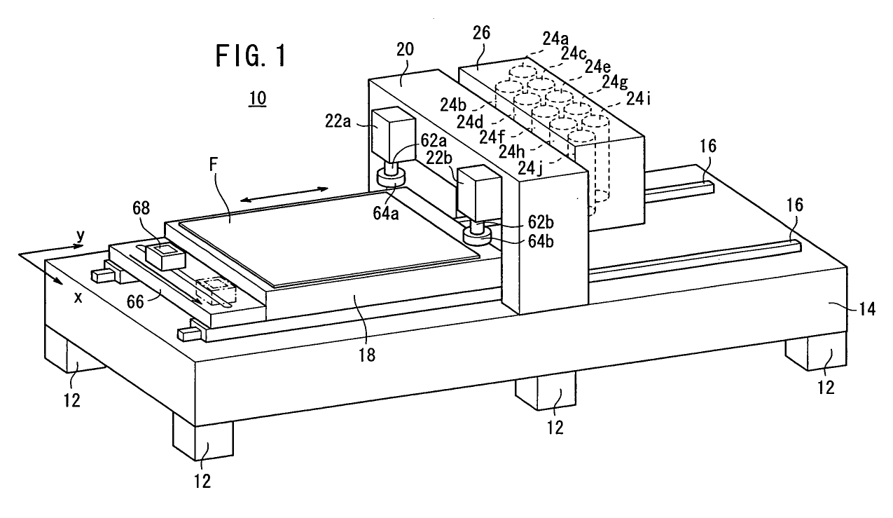

FIG. 1 shows an exposure apparatus 10 for performing an exposure process on a printed wiring board, etc., to which an image recording method and an image recording device according to an embodiment of the present invention are applied. The exposure apparatus 10 has a bed 14, which suffers very little deformations, supported by a plurality of legs 12, and an exposure stage 18 mounted on the bed 14 by two guide rails 16 for reciprocating movement in the directions indicated by the arrow. An elongate rectangular substrate F (mage recording medium) coated with a photosensitive material is attracted to and held on the exposure stage 18.

A portal column 20 is mounted centrally on the bed 14 over the guide rails 16. Two CCD cameras 22a, 22b are fixed to one side of the column 20 for detecting the position in which the substrate F is mounted with respect to the exposure stage 18. A scanner 26 having a plurality of exposure heads 24a through 24j positioned and held therein for recording an image on the substrate F by way of exposure is fixed to the other side of the column 20. The exposure heads 24a through 24j are arranged in two staggered rows in a direction perpendicular to the directions in which the substrate F is scanned (the directions in which the exposure stage 18 is movable). Flash lamps 64a, 64b are mounted on the CCD cameras 22a, 22b, respectively, by respective rod lenses 62a, 62b. The flash lamps 64a, 64b apply an infrared radiation to which the substrate F is insensitive, as illuminating light, to an image capturing area for the CCD cameras 22a, 22b.

A guide table 66 which extends in the direction perpendicular to the directions in which the exposure stage 18 is movable is mounted on an end of the bed 14. The guide table 66 supports thereon a photosensor 68 movable in the direction indicated by the arrow x for detecting the amount of light of laser beams L emitted from the exposure heads 24a through 24j.

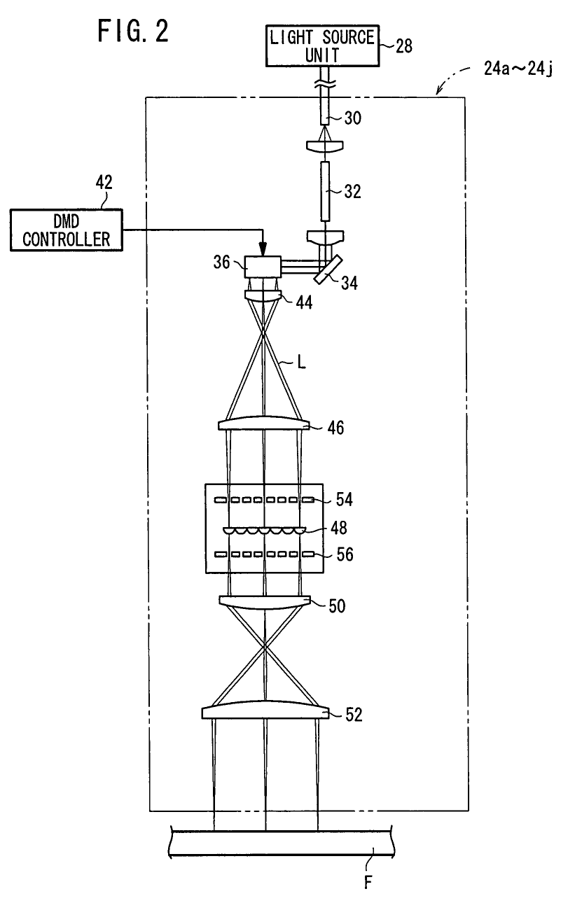

FIG. 2 shows a structure of each of the exposure heads 24a through 24j. A combined laser beam L emitted from a plurality of semiconductor lasers of light source units 28 is introduced through an optical fiber 30 into each of the exposure heads 24a through 24j. A rod lens 32, a reflecting mirror 34, and a digital micromirror device (DMD) 36 are successively arranged on an exit end of the optical fiber 30 into which the laser beam L is introduced.

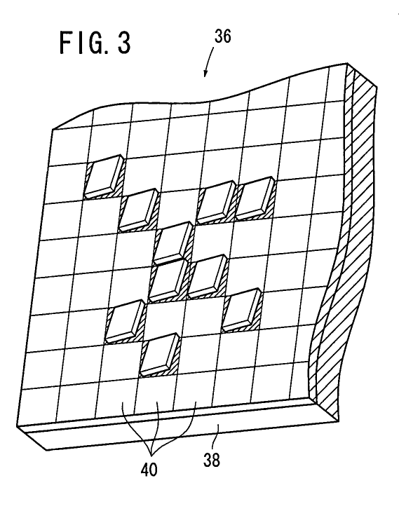

As shown in FIG. 3, the DMD 36 comprises a number of micromirrors 40 (recording components) that are swingably disposed in a matrix pattern on SRAM cells (memory cells) 38. A material having a high reflectance such as aluminum or the like is evaporated on the surface of each of the micromirrors 40. When a digital signal according to image recording data is written in the SRAM cells 38 by a DMD controller 42, the micromirrors 40 are tilted in given directions depending on the applied digital signal. Depending on how the micromirrors 40 are tilted, the laser beam L is turned on or off.

In the direction in which the laser beam L reflected by the DMD 36 that is controlled to be turned on or off is emitted, there are successively disposed first image focusing optical lenses 44, 46 of a magnifying optical system, a microlens array 48 having may lenses corresponding to the respective micromirrors 40 of the DMD 36, and second image focusing optical lenses 50, 52 of a zooming optical system. Microaperture arrays 54, 56 for removing stray light and adjusting the laser beam L to a predetermined diameter are disposed in front of and behind the microlens array 48.

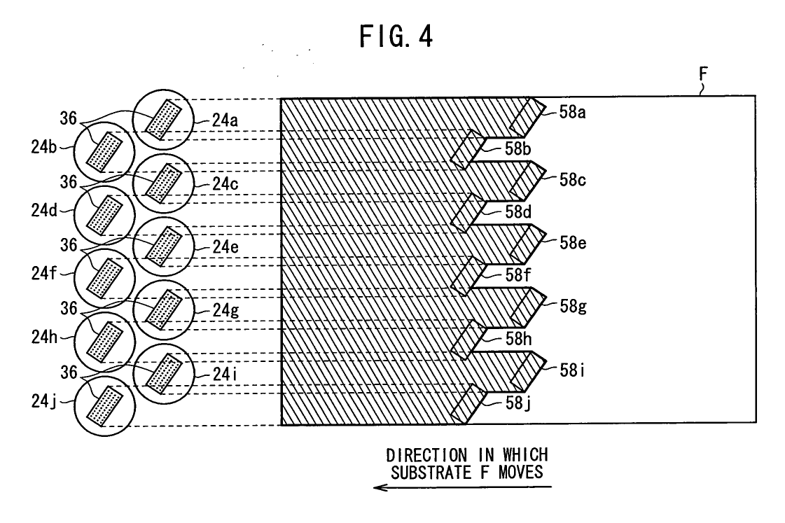

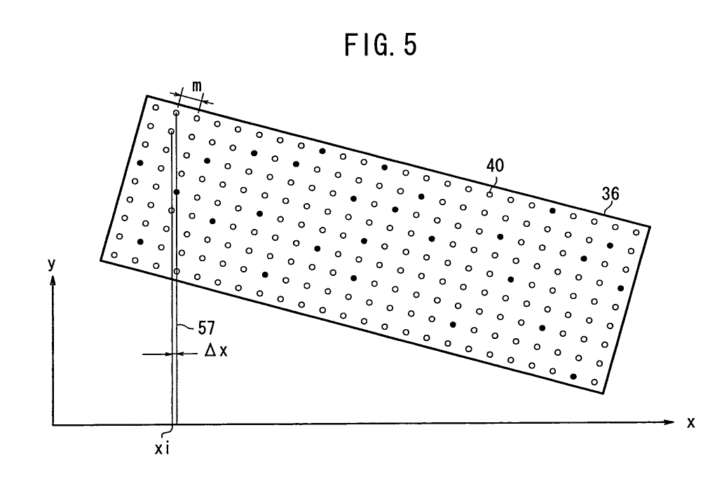

As shown in FIGS. 4 and 5, the DMDs 36 incorporated in the respective exposure heads 24a through 24j are inclined a predetermined angle to the direction in which the exposure heads 24a through 24j move, for achieving higher resolution. Specifically, the DMDs 36 that are inclined to the direction in which the substrate F is scanned (the direction indicated by the arrow y) reduce the interval Ax between the micromirrors 40 in the direction (the direction indicated by the arrow x) perpendicular to the direction in which the substrate F is scanned, to a value smaller than the interval m between the micromirrors 40 of the DMDs 36 in the direction in which they are arrayed, thereby increasing the resolution.

In FIG. 5, a plurality of micromirrors 40 are disposed on one scanning line 57 in the scanning direction (the direction indicated by the arrow y) of the DMDs 36. The substrate F is exposed to a multiplicity of images of one pixel by laser beams L that are guided to substantially the same position by these micromirrors 40. In this manner, amount-of-light irregularities between the micromirrors 40 can be averaged. To make the exposure heads 24a through 24j seamless, they are arranged such that exposure areas 58a through 58j which are exposed at a time by the respective exposure heads 24a through 24j overlap in the direction indicated by arrow x.

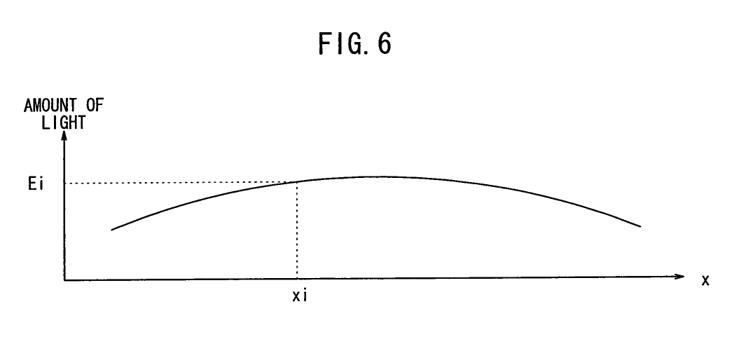

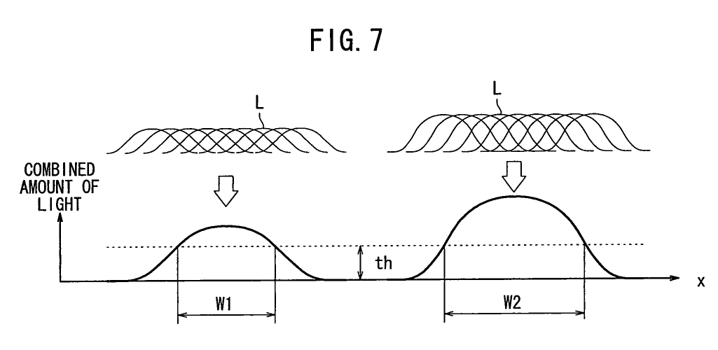

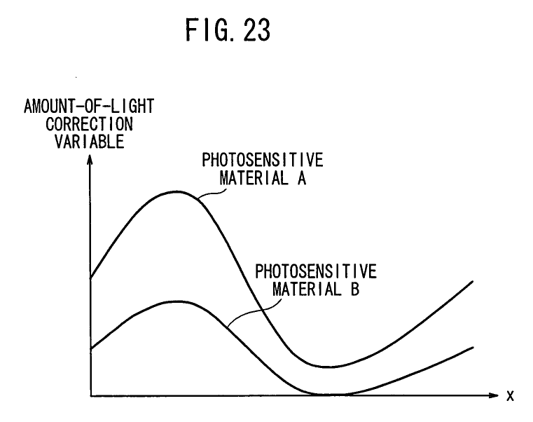

As shown in FIG. 6, the amount of light of the laser beam L that is guided to the substrate F by each of the micromirrors 40 of the DMDs 36 has a locality caused by the reflectance of the DMDs 36, the optical system, etc. along the direction indicated by the arrow x in which the exposure heads 24a through 24j are arrayed. With such a locality, as shown in FIG. 7, when an image is recorded on the substrate F by laser beams L having a smaller combined amount of light which are reflected by a plurality of micromirrors 40 and when an image is recorded on the substrate F by laser beams L having a greater combined amount of light which are reflected by the micromirrors 40, the images have respective different widths W1, W2 in the direction indicated by the arrow x which are determined by a threshold th beyond which the photosensitive material applied to the substrate F is sensitive to the laser beams L. When the exposed substrate F is processed by a developing process, an etching process, and a peeling process, as shown in FIG. 23, the widths of the images are also varied by photoresist lamination irregularities, developing process irregularities, etching process irregularities, and peeling process irregularities as well as the locality of the amount of light of the laser beams L.

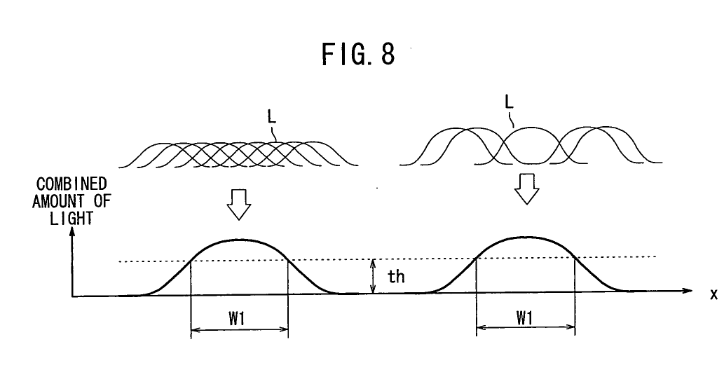

According to the present embodiment, in view of the above various factors responsible for the variations, the number of micromirrors 40 that are used to form one pixel of image on the substrate F is controlled using mask data to produce images having a constant width W1 regardless of the positions in the direction indicated by the arrow x taking the various processes to the final peeling process into consideration, as shown in FIG. 8.

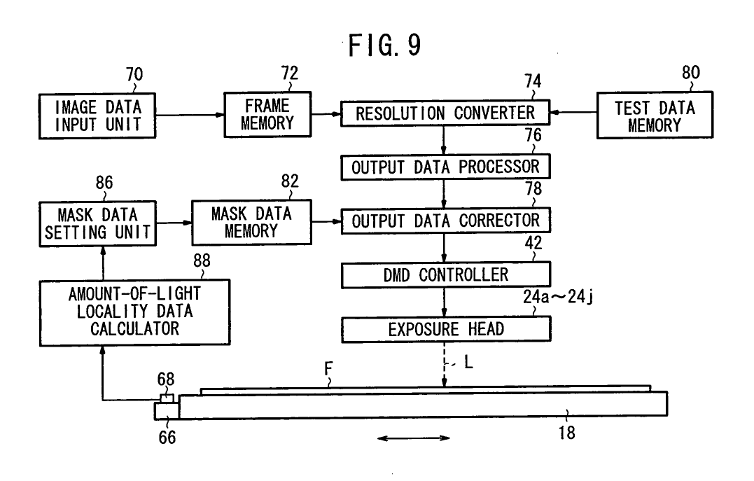

FIG. 9 shows in block form a control circuit of the exposure apparatus 10 having a function to perform such a control process.

The exposure apparatus 10 has an image data input unit 70 for entering image data to be recorded on the substrate F by exposure, a frame memory 72 for storing the two-dimensional image data, a resolution converter 74 for converting the resolution of the image data stored in the frame memory 72 into a higher resolution depending on the size and layout of the micromirrors 4 of the DMDs 36 of the exposure heads 24a through 24j, an output data processor 76 for processing the resolution-converted image data into output data to be assigned to the micromirrors 40, an output data corrector 78 for correcting the output data according to mask data, a DMD controller 42 (recording component control means) for controlling the DMDs 36 according to the corrected output data, and the exposure heads 24a through 24j for recording a desired image on the substrate F with the DMDs 36 that are controlled by the DMD controller 42.

A test data memory 80 (test data storage means) for storing test data is connected to the resolution converter 74. The test data are data for recording by exposure a test pattern, which comprises a repetition of constant line widths and constant space widths, on the substrate F, and generating mask data based on the test pattern.

A mask data memory 82 (correction data storage means) for storing mask data is connected to the output data corrector 78. The mask data are data for specifying micromirrors 40 to be turned off at all times. The mask data are set by a mask data setting unit 86. The exposure apparatus 10 also has an amount-of-light locality data calculator 88 for calculating amount-of-light locality data based on the amounts of light of the laser beams L detected by the photosensor 68. The amount-of-light locality data calculated by the amount-of-light locality data calculator 88 are supplied to the mask data setting unit 86 (mask data setting means).

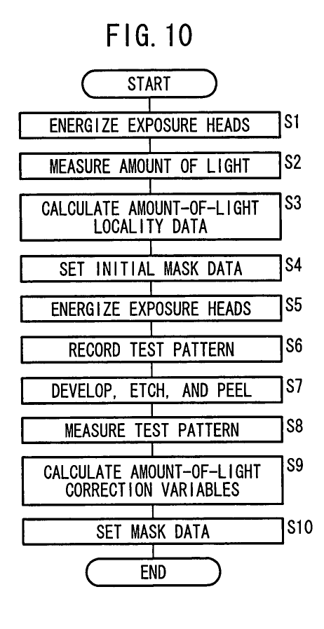

The exposure apparatus 10 according to the present embodiment is basically constructed as described above. A process of setting mask data will be described below with reference to a flowchart shown in FIG. 10.

First, the exposure stage 18 is moved to place the photosensor 68 beneath the exposure heads 24a through 24j. Thereafter, the exposure heads 24a through 24j are energized (step S1). At this time, the DMD controller 42 sets all the micromirrors 40 of the DMDs 36 to an on-state for guiding the laser beams L to the photosensor 68.

While moving in the direction indicated by the arrow x in FIG. 1, the photosensor 68 measures the amounts of light of the laser beams L emitted from the exposure heads 24a through 24j, and supplies the measured amounts of light to the amount-of-light locality data calculator 88 (step S2). Based on the measured amounts of light, the amount-of-light locality data calculator 88 calculates amount-of-light locality data of the laser beam L at each position xi (i=1, 2, . . . ) in the direction indicated by the arrow x, and supplies the calculated amount-of-light locality data to the mask data setting unit 86 (step S3).

Based on the supplied amount-of-light locality data, the mask data setting unit 86 generates initial mask data for making constant the amount Ei (i=1, 2, . . . ) of light of the laser beam L at each position xi (i=1, 2, . . . ) on the substrate F, and stores the initial mask data in the mask data memory 82 (step S4). The initial mask data are established as data for controlling some of a plurality of micromirrors 40 for forming one image pixel at each position xi on the substrate F, into an off-state according to the amount-of-light locality data in order to eliminate the amount-of-light locality shown in FIG. 6, for example. In FIG. 5, those micromirrors 40 that have been set to the off-state by the initial mask data are illustrated as black dots.

After the initial mask data have been established, the exposure stage 18 is moved to place the substrate F beneath the exposure heads 24a through 24j, and the exposure heads 24a through 24j are energized based on test data (step S5).

The resolution converter 74 reads test data from the test data memory 80, converts the resolution of the test data into a resolution corresponding to the micromirrors 40 of the DMDs 36, and supplies the resolution-converted test data to the output data processor 76. The output data processor 76 processes the resolution-converted image data into test output data representing signals for selectively turning on and off the micromirrors 40, and supplies the test output data to the output data corrector 78. The output data corrector 78 forcibly turns off those test output data for the micromirrors 40 which correspond to the initial mask data supplied from the mask data memory 82, and then supplies the corrected test output data to the DMD controller 42.

The DMD controller 42 selectively turns on and off the micromirrors 40 of the DMDs 36 according to the test output data that have been corrected by the initial mask data, thereby applying the laser beams L emitted from the light source units 28 to the substrate F to record a test pattern by exposure (step S6). Since the test pattern is formed according to the test output data that have been corrected by the initial mask data, the test pattern is free of the amount-of-light locality of the laser beams L.

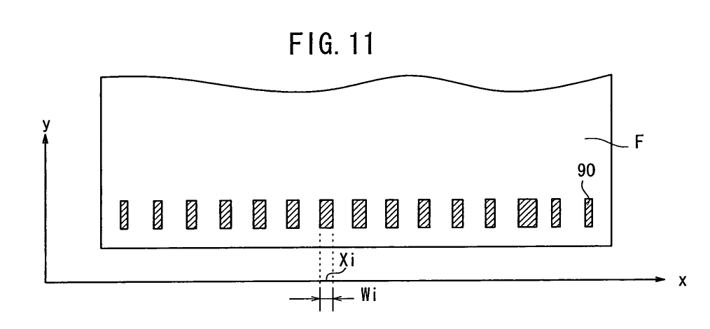

The developing process, the etching process, and the resist peeling process are performed on the substrate F with the test pattern recorded thereon by exposure, producing the substrate F with the test pattern remaining thereon (step S7). As shown in FIG. 11, for example, the test pattern comprises a plurality of rectangular test patterns 90 formed at respective positions xi (i=1, 2, . . . ) spaced along the direction indicated by the arrow x and having line widths Wi (i=1, 2, . . . ). In a locality-free ideal state, the test pattern is recorded based on test output data wherein the line widths Wi and space widths are constant regardless of the position xi.

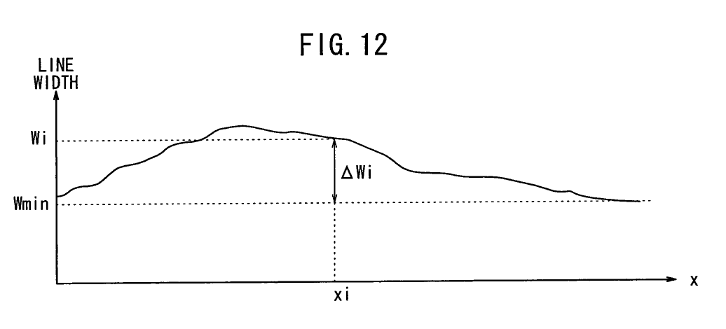

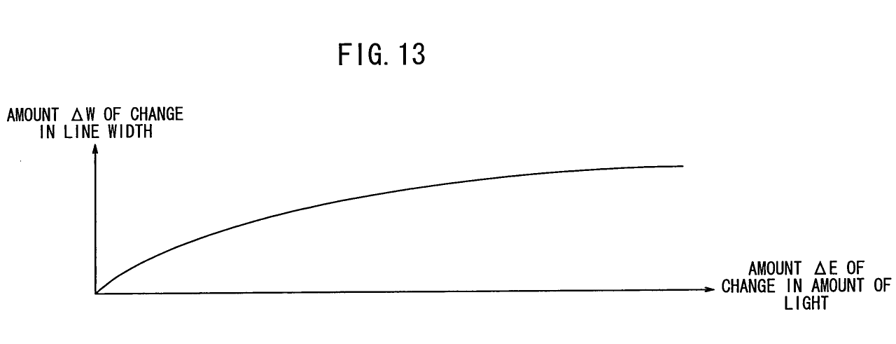

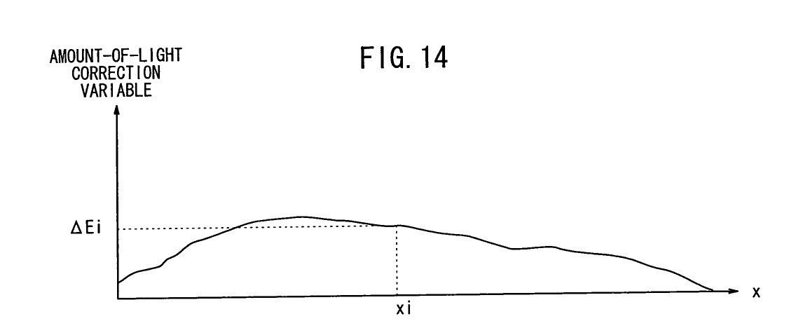

The line widths Wi (i=1, 2, . . . ) of the test patterns 90 on the substrate F are measured (step S8). From the measured result, amount-of-light correction variables ΔEi (i=1, 2, . . . ) for correcting the supplied line widths Wi (i=1, 2, . . . ) into a minimum line width Wmin are calculated (step S9). FIG. 12 shows the relationship between the positions xi (i=1, 2, . . . ) in the direction indicated by the arrow x and the measured line widths Wi (i=1, 2, . . . ). FIG. 13 shows the relationship between amounts ΔE of change in the amount of light of the laser beam L applied to the substrate F and corresponding amounts ΔW of change in the line widths. This relationship is determined in advance by an experiment. The amount-of-light correction variables ΔEi (i=1, 2, . . . ) are calculated as amounts ΔEi of change in the amounts of light at respective positions xi for obtaining amounts ΔWi of change in the line widths for correcting the measured line widths Wi (i=1, 2, . . . ) into a minimum line width Wmin (see FIG. 14).

Based on the calculated amount-of-light correction variable ΔEi (i=1, 2, . . . ), the mask data setting unit 86 adjusts the initial mask data set in step S4 to establish mask data (step S10). The mask data are established as data for determining micromirrors 40 to be set to the off-state among the micromirrors 40 that are used to form one pixel of image at each position xi (i=1, 2, . . . ) on the substrate F, according to the amount-of-light correction variables ΔEi (i=1, 2, . . . ). The established mask data are stored, in place of the initial mask data, in the mask data memory 82.

Using the proportion of an amount-of-light correction variable ΔEi (i=1, 2, . . . ) to an amount Ei (i=1, 2, . . . ) of light at the time the output data are corrected with the initial mask data (see FIG. 6), and the number N of micromirrors 40 for forming one pixel, the number n of micromirrors 40 to be set to the off-state is calculated by:

n=N·ΔEi/Ei

The mask data are established to set the n micromirrors 40, among the N micromirrors 40, to the off-state.

After the mask data have thus been established, a desired wiring pattern is recorded by way of exposure on the substrate F.

First, image data representing a desired wiring pattern are entered from image data input unit 70. The entered image data are stored in the frame memory 72, and then supplied to the resolution converter 74. The resolution converter 74 converts the resolution of the image data into a resolution depending on the resolution of the DMDs 36, and supplies the resolution-converted image data to the output data processor 76. The output data processor 76 calculates output data representing signals for selectively turning on and off the micromirrors 40 of the DMDs 36 from the resolution-converted image data, and supplies the calculated output data to the output data corrector 78.

The output data corrector 78 reads the mask data from the mask data memory 82, corrects the on- and off-states of the micromirrors 40 that are represented by the output data, using the mask data, and supplies the corrected output data to the DMD controller 42.

The DMD controller 42 energizes the DMDs 36 based on the corrected output data to selectively turn on and off the micromirrors 40. The laser beams L emitted from the light source unit 28 and introduced through the optical fibers 30 into the exposure heads 24a through 24j are applied via the rod lenses 32 and the reflecting mirrors 34 to the DMDs 36. The laser beams L selectively reflected in desired directions by the micromirrors 40 of the DMDs 36 are magnified by the first image focusing optical lenses 44, 46, and then adjusted to a predetermined beam diameter by the microaperture arrays 54, the microlens arrays 48, and the microaperture arrays 56. Thereafter, the laser beams L are adjusted to a predetermined magnification by the second image focusing optical lenses 50, 52, and then guided to the substrate F. The exposure stage 18 moves along the bed 14, during which time a desired wiring pattern is recorded on the substrate F by the exposure heads 24a through 24j that are arrayed in the direction perpendicular to the direction in which the exposure stage 18 moves.

After the wiring pattern has been recorded on the substrate F, the substrate F is removed from the exposure apparatus 10, and then the developing process, the etching process, and the peeling process are performed on the substrate F. The amount of light of the laser beam L applied to the substrate F has been adjusted in view of the processes up to the final peeling process based on the mask data. Therefore, it is possible to obtain a highly accurate wiring pattern having a desired line width.

In the above embodiment, the test patterns 90 shown in FIG. 11 are recorded on the substrate F by way of exposure, and the mask data are determined by measuring the line widths Wi (i=1, 2, . . . ). However, mask data may be determined by measuring space widths between adjacent ones of the test patterns 90. If it is difficult to measure the line widths Wi (i=1, 2, . . . ) or the space widths highly accurately, then the densities of small areas established around the respective positions xi (i=1, 2, . . . ) of the test patterns 90 may be measured, and mask data may be determined from a distribution of the measured densities.

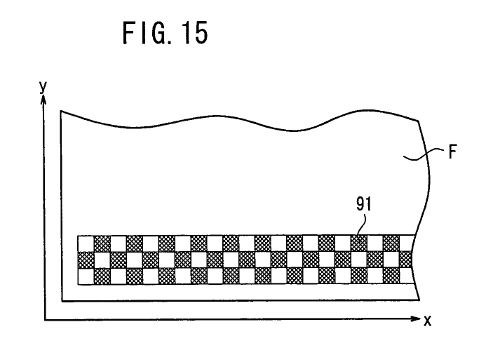

Instead of recording the test patterns 90 on the substrate F by way of exposure, as shown in FIG. 15, halftone dot patterns 91 having a predetermined halftone dot % may be recorded by way of exposure on the substrate F, and mask data may be determined by measuring halftone dot % or densities of the halftone dot patterns 91.

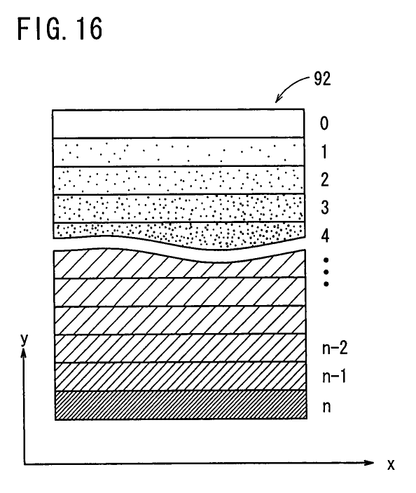

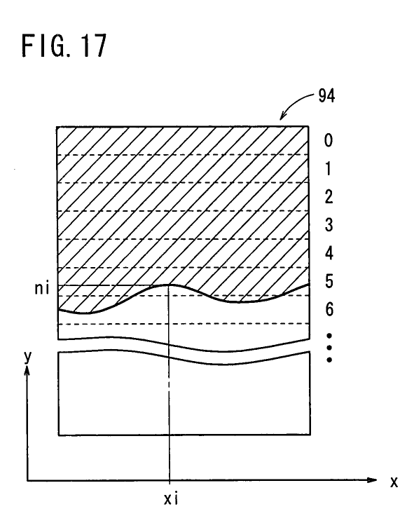

Gray scale data 92 in n (n=1, 2, . . . ) steps shown in FIG. 16 may be set as test data in the test data memory 80, and using the gray scale data 92, gray scale patterns for increasing amounts of light stepwise in the direction indicated by the arrow y on the substrate F may be recorded by way of exposure on the substrate F. Thereafter, the substrate F may be developed, and then, as shown in FIG. 17, the range of resist patterns 94 remaining on the substrate F or the range of resist patterns 94 not remaining on the substrate F may be measured, the number ni of corresponding steps of the gray scale data 92 at the positions xi (i=1, 2, . . . ) on the resist patterns 94 may be determined, and mask data may be determined based on the number ni.

Similarly for the test patterns 90, mask data may be determined by measuring resist patterns after they are developed.

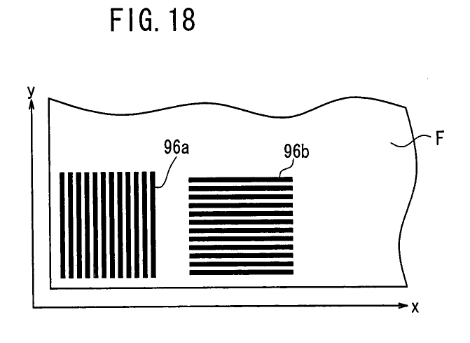

Alternatively, mask data may be determined by measuring the line widths or space widths of test patterns arrayed in two different directions. For example, as shown in FIG. 18, a test pattern 96a of parallel bars along the scanning direction (the direction indicated by the arrow y) and a test pattern 96b of parallel bars along the line perpendicular to the scanning direction (the direction indicated by the arrow x) may be recorded in each position xi on the substrate F, an amount-of-light correction variable may be calculated based on the average value of line widths of the test patterns 96a, 96b, and mask data may be determined. Using test patterns arranged in two different directions, it is possible to eliminate factors responsible for line width variations depending on the direction of the test patterns.

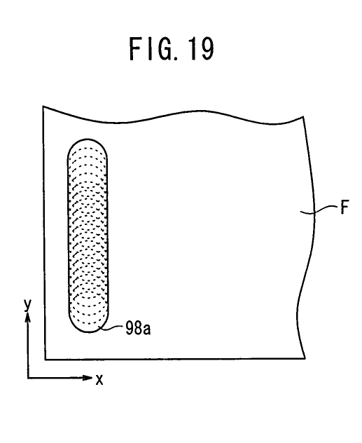

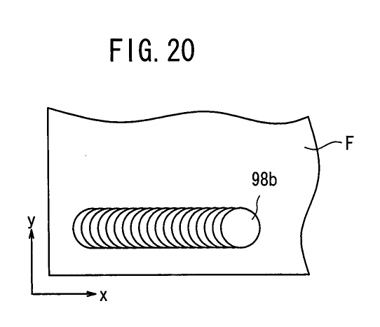

One factor that is responsible for varying the line widths may be that an edge of a test pattern is recorded differently in the scanning direction and the direction perpendicular to the scanning direction. Specifically, as shown in FIG. 19, an edge 98a of a test pattern in the direction in which the substrate F is scanned (the direction indicated by the arrow y), is recorded by a single spot or a plurality of spots of the laser beam L that move in the direction indicated by the arrow y, i.e., the direction in which the substrate F moves. On the other hand, as shown in FIG. 20, an edge 98b of a test pattern in the direction indicated by the arrow x is recorded by a plurality of spots of the laser beam L that do not move relatively to the substrate F. The difference as to how the edges 98a, 98b are recorded is possibly liable to develop different line widths. There is also a possibility of different line widths if the spots of the laser beam L are not of a circular shape.

Test patterns may be arranged in three or more directions, rather than the two directions described above. Test patterns that are inclined to the directions indicated by the arrows x, y may also be employed. A prescribed circuit pattern may be formed as a test pattern, and the circuit pattern may be measured to correct the amounts of light.

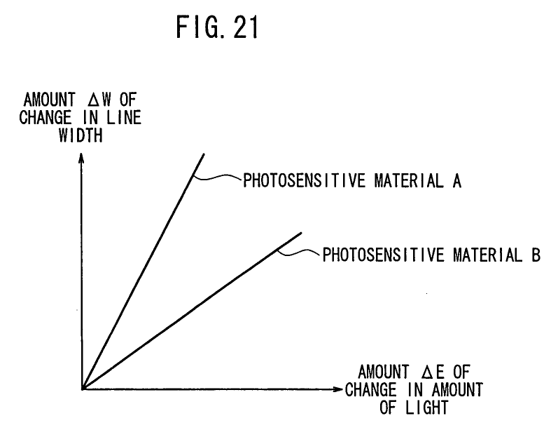

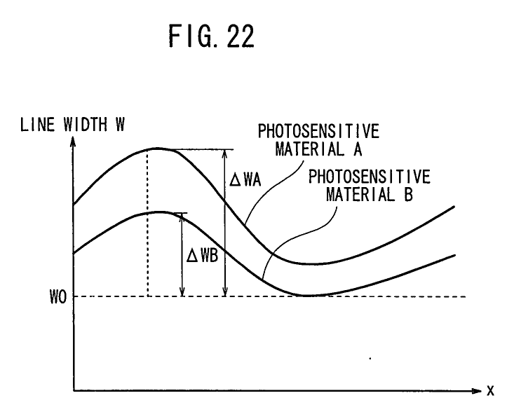

Alternatively, amount-of-light correction variables may be determined depending on the types of photosensitive materials applied to substrates F, and then mask data may be set. Specifically, as shown in FIG. 21, the relationship between an amount ΔE of change in the amount of light of the laser beam L applied to the substrate F and an amount ΔW of change in the line width, or the relationship between the amount of change in the beam diameter of the laser beam L and an amount ΔW of change in the line width, differ depending on the types of photosensitive materials A, B. The different relationships are caused by different gradation characteristics of the photosensitive materials A, B. As shown in FIG. 22, different line widths W may be produced even when a test pattern is recorded on the photosensitive materials A, B under the same conditions. In FIG. 21, the relationship between the amount ΔE of change in the amount of light and the amount ΔW of change in the line width is approximated by a straight line.

For recording patterns of the same line width regardless of the different characteristics of the photosensitive materials A, B, it is necessary to establish amount-of-light correction variables depending on the photosensitive materials A, B from the characteristic curves (FIG. 21) of the photosensitive materials A, B with respect to the relationship between the amount AE of change in the amount of light and the amount ΔW of change in the line width, and amounts of ΔWA, ΔWB (FIG. 22) of change in the line width from a reference line width W0 (e.g., a minimum value of the line width W) at each position xi for the respective photosensitive materials A, B. FIG. 23 shows an example of amount-of-light correction variables established for the photosensitive materials A, B.

According to the present embodiment, the mask data setting unit 86 sets mask data based on the amount-of-light correction variables that are determined for the photosensitive materials A, B, and stores the established mask data in the mask data memory 82. For exposing the substrate F to a desired wiring pattern, mask data corresponding to the type of the photosensitive material entered by the operator are read from the mask data memory 82, and output data supplied from output data processor 76 are corrected by the mask data. In this manner, a highly accurate wiring pattern free of line width variations can be recorded on the substrate F independently of the type of the photosensitive material. Alternatively, a table representing the relationship between amounts of light (beam diameters) and line widths may be prepared, and a locality correction variable may be determined by referring to the table based on the amount of light (the beam diameter).

The exposure apparatus 10 may appropriately be used to expose a dry film resist (DFR) or a liquid resist in a process of manufacturing a multilayer printed wiring board (PWB), to form a color filter or a black matrix in a process of manufacturing a liquid crystal display (LCD), to expose a DFR in a process of manufacturing a TFT, and to expose a DFR in a process of manufacturing a plasma display panel (PDP), etc., for example. The present invention is also applicable to an image recording apparatus having an ink jet recording head. The present invention is also applicable to exposure apparatus for use in the field of printing and the field of photography.

1. A method of recording an image on an image recording medium by controlling a plurality of recording components depending on image data, comprising the steps of:
controlling said recording components based on test data to record a test pattern on said image recording medium;
determining correction data depending on a recorded position of said test pattern to hold the recorded test pattern in a desired recorded state;
determining mask data for controlling particular recording components into an off-state based on said correction data; and
controlling said recording component based on the image data for determining on- and off-states and said mask data for determining the off-state to record the image on said image recording medium.

2. A method according to claim 1, wherein said recording components guide light beams to said image recording medium depending on said image data to record the image thereon by way of exposure.

3. A method according to claim 1, wherein said desired recorded state comprises a desired line width recorded on said image recording medium.

4. A method according to claim 1, wherein said desired recorded state comprises a constant line width at a plurality of recording positions on said image recording medium.

5. A method according to claim 1, wherein said test data comprise data for recording said test pattern which has a predetermined width or a predetermined interval, and said correction data are determined to make the width or interval of said test pattern constant independently of recording positions.

6. A method according to claim 1, wherein said test data comprise data for recording said test pattern which has a predetermined density, and said correction data are determined to make the density of said test pattern constant independently of recording positions.

7. A method according to claim 1, wherein said test data comprise data for recording said test pattern which has a predetermined halftone dot %, and said correction data are determined to make the halftone dot % of said test pattern constant independently of recording positions.

8. A method according to claim 1, wherein said test data comprise data for recording a grayscale of steps having densities which vary stepwise, as said test pattern, and said correction data are determined based on the range of said grayscale which remains on said image recording medium or which does not remain on said image recording medium after said grayscale recorded on said image recording medium is developed.

9. A method according to claim 1, wherein said correction data or said mask data are determined depending on said image recording medium.

10. An apparatus for recording an image on an image recording medium by controlling a plurality of recording components depending on image data, comprising:
test data storage means for storing test data for recording a test pattern on said image recording medium;
mask data setting means for setting mask data for controlling particular recording components into an off-state in order to hold said recorded test pattern recorded on said image recording medium according to said test data, in a desired recorded state;
mask data storage means for storing said mask data; and
recording component control means for controlling said recording components based on the image data for determining on- and off-states and said mask data for determining the off-state.

11. An apparatus according to claim 10, wherein said recording components comprise exposure components for guiding light beams to said image recording medium depending on said image data to record the image thereon by way of exposure.

12. An apparatus according to claim 11, wherein said exposure components make up a spatial light modulator for modulating an incident light beam depending on said image data and guiding the modulated light beam to said image recording medium.

13. An apparatus according to claim 12, wherein said spatial light modulator comprises a micromirror device including a two-dimensional array of micromirrors having reflecting surfaces for reflecting said light beam, said reflecting surfaces being angularly variable depending on said image data.

14. An apparatus according to claim 10, wherein said desired recorded state comprises a desired line width recorded on said image recording medium.

15. An apparatus according to claim 10, wherein said desired recorded state comprises a constant line width at a plurality of recording positions on said image recording medium.

16. An apparatus according to claim 10, wherein said test data comprise data for recording said test pattern which has a predetermined width or a predetermined interval.

17. An apparatus according to claim 10, wherein said test data comprise data for recording said test pattern which has a predetermined density.

18. An apparatus according to claim 10, wherein said test data comprise data for recording said test pattern which has a predetermined halftone dot %.

19. An apparatus according to claim 10, wherein said mask data storage means stores said mask data depending on said image recording medium.
